(19) United States
(12) Patent Application Publication
(10) Pub. No.: US 2016/0003182 A1
(43) Pub. Date: Jan. 7, 2016

(54) Control Device for Internal Combustion Engine

(71) Applicant: HITACHI AUTOMOTIVE SYSTEMS, LTD., Hitachinaka-shi, Ibaraki (JP)

(72) Inventors: Yoshihisa FUJII, Hitachinaka-shi (JP); Takao FUKUDA, Hitachinaka-shi (JP); Masahiro TOYOHARA, Hitachinaka-shi (JP)

(21) Appl. No.: 14/768,709

(22) PCT Filed: Feb. 7, 2014
(86) PCT No.: PCT/JP2014/052821

§ 371 Date: Aug. 18, 2015

(30) Foreign Application Priority Data
Feb. 20, 2013 (JP) 2013-030544

(51) Int. Cl. F02D 41/20; F02M 51/06; F02D 41/30

(52) U.S. Cl. CPC F02D 41/20; F02D 41/30; F02M 51/06

(57) ABSTRACT

A control device is provided which prevents a temperature increase within an ECU by suppressing heat generation in the ECU without using a new cooling device such as a blow fan. In one step, an open valve voltage target value is calculated. An open valve voltage is a voltage applied to a fuel injection valve when opening the fuel injection valve. As the number of times of the multi-stage injections increases, an opportunity to boost the open valve voltage increases, heat is generated in the open valve voltage boosting section, a temperature within the ECU excessively increases, and there is a concern that an electronic component within the ECU malfunctions or fails. Thus, a temperature sensor is provided on an inside of the ECU and if an ECU temperature is high, it is determined that heat is generated in the open valve voltage generating section and the open valve voltage target value is reduced.

### TECHNICAL FIELD

The present invention relates to a control device of an internal combustion engine for controlling a fuel injection valve that directly injects fuel into a combustion chamber.

### BACKGROUND ART

In recent years, due to national pollution regulations, emission regulations and fuel consumption regulations of automobiles have become strict. Particularly, in a cylinder injection type internal combustion engine, there are advantages of high output and low fuel consumption with respect to an intake port injection type internal combustion engine. However, fuel having a large particle size is likely to adhere and remain on the crown of a piston or the wall surface of a cylinder bore, or a non-uniform portion of a mixed condition of fuel and air is likely to occur. Thus, hydro-carbon (HC) or a fine particulate matter is likely to be exhausted and it causes exhaust performance to be deteriorated.

As exhaust performance improvement of such a cylinder injection type internal combustion engine, a multi-stage injection control for performing a plurality of times of fuel injections in one cycle of the internal combustion engine is disclosed in PTL 1. According to this control, it is possible to reduce the adhesion amount of fuel within the combustion chamber, to increase uniformity of mixture, and to expect improvement of exhaust performance.

On the other hand, the multi-stage injection has a problem that the heat generation in a control device (ECU) is increased. In the cylinder injection type internal combustion engine, in order to open the fuel injection valve against a high fuel pressure, it has been known that a battery voltage is boosted and the boosted voltage (open valve voltage) is used. However, open valve voltage generation means is accompanied by heat generation when boosting. If an opportunity of fuel injection increases in the multi-stage injection, an opportunity of boosting also increases and then heat further generates. As a result, a temperature within the ECU which incorporates the open valve voltage generation means excessively increases and the electronic component within the ECU is likely to malfunction or fail.

Thus, a technique for cooling the electronic control device by a blowing fan if the temperature within the ECU excessively increases is disclosed in PTL 2.

### CITATION LIST

### Patent Literature

PTL 1: JP-A-2011-132898

PTL 2: Japanese Patent No. 4319710

### SUMMARY OF INVENTION

### Technical Problem

In the technique described in PTL 2, it is necessary to newly add a blowing fan and manufacturing costs are increased. The present invention has been made in view of such a problem and an object of the invention is to provide a control device for preventing a temperature increase within the ECU without using a new cooling device such as a blowing fan by suppressing heat generation in an ECU.

### Solution to Problem

To solve the above problem, a control device of the invention includes a boosting circuit that generates a boosted voltage by boosting a battery voltage; a driving circuit that drives a fuel injection valve by applying the battery voltage and the boosted voltage to a coil; and a boosted voltage adjusting section that adjusts a target boosted voltage of the boosting circuit based on the driving state of a vehicle.

### Advantageous Effects of Invention

According to the invention, heat generation in an ECU is suppressed by adjusting a target value of an open valve voltage by a measured value or an estimated value of a temperature of the control device and it is possible to prevent a temperature increase of the control device without using a new cooling device such as a blowing fan.

### BRIEF DESCRIPTION OF DRAWINGS

FIG. 1 is a system configuration view of an internal combustion engine.

FIG. 2 is a circuit configuration diagram of a fuel injection device.

FIG. 3 is a diagram illustrating a flowchart of fuel injection control.

FIG. 4 is a block diagram of the fuel injection control.

FIG. 5 is a diagram illustrating correction of a fuel injection valve energizing time.

### DESCRIPTION OF EMBODIMENTS

Hereinafter, an embodiment of the invention will be described with reference to the drawings.

### First Embodiment

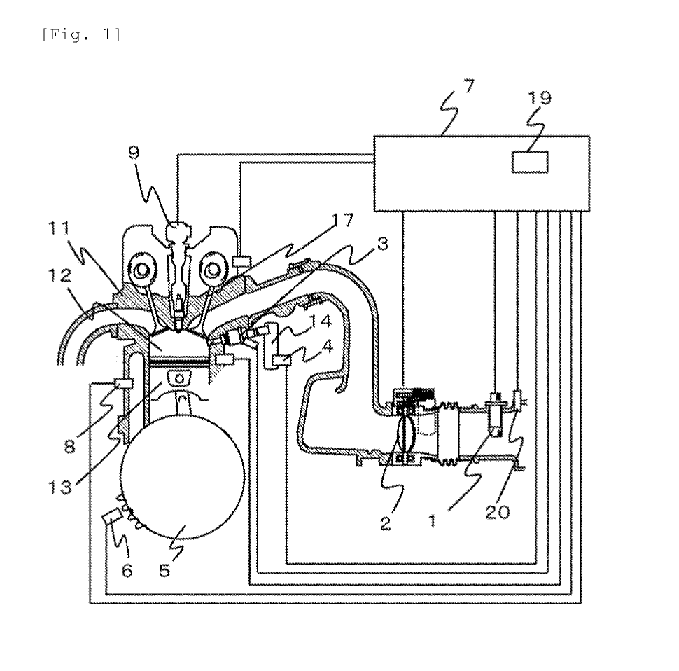

FIG. 1 is a system configuration view of an internal combustion engine of the invention. This view illustrates a cross-sectional view of an internal combustion engine 11.

An intake amount of intake air is adjusted by a throttle valve 2. The intake amount of the intake air is measured by an air flow meter 1 and a signal thereof is transmitted to an ECU (engine control unit) 7.

Thereafter, the intake air passes through an intake valve 17, enters a combustion chamber 12 of the internal combustion engine, and forms mixed gas together with fuel injected from a fuel injection valve 3. Opening and closing of the fuel injection valve 3 is controlled by a signal from the ECU 7.

The mixed gas of fuel and the intake air formed within the combustion chamber 12 is ignited by a spark ignition device 9. Ignition of the spark ignition device 9 is controlled by a signal from the ECU 7. The ignited mixed gas is combusted and pushes down a piston 13 by expanding. An output shaft (crankshaft) is connected to the piston 13, is rotated by the piston 13 that is being pushed down, and outputs energy.

Furthermore, the crankshaft includes a crank angle signal plate 5 and a crank angle sensor 6 for detecting a rotational angular speed (engine speed) and an angular position of the crankshaft, and a signal from the crank angle sensor 6 is transmitted to the ECU 7.

Additionally, this system includes the following sensors and all transmit signals to the ECU 7. A fuel pressure sensor 4 is a sensor for measuring the pressure within a fuel supply passage 14 to the fuel injection valve 3. A water temperature sensor 8 is mounted on a cooling water passage of the internal combustion engine 11 and is a sensor for measuring a cooling water temperature of the engine. An ECU temperature sensor 19 is mounted on an inside of the ECU 7 and is a sensor for measuring a temperature of the inside of the ECU. An intake air temperature sensor 20 is a sensor for measuring an intake air temperature (outside air temperature).

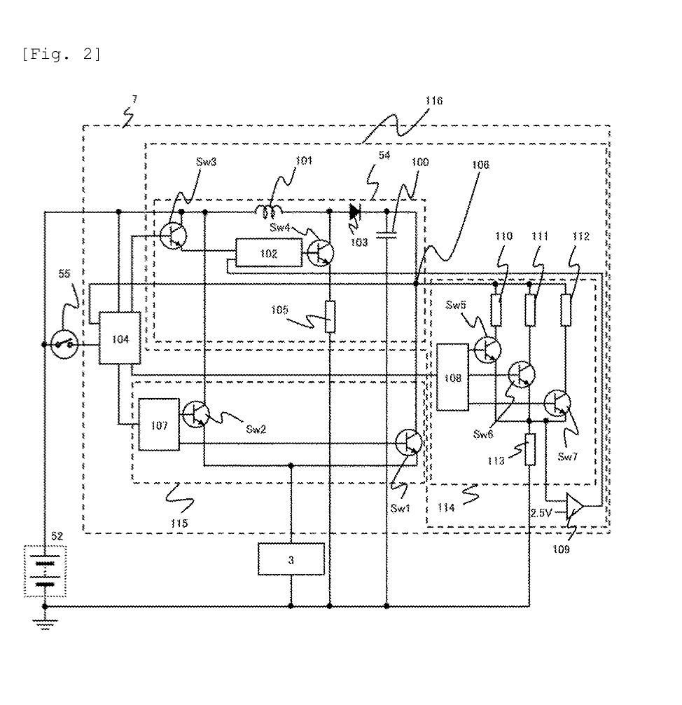

Next, FIG. 2 illustrates a circuit configuration diagram of the fuel injection device.

There are the fuel injection valve 3 for injecting fuel into the combustion chamber of the internal combustion engine and the ECU 7 for driving and controlling the fuel injection valve 3. The ECU 7 receives power supply from a battery 52.

A CPU 104, a fuel injection valve driving section 115, and an open valve voltage generating section 116 are provided on the inside of the ECU 7. The CPU 104 controls the entirety of the internal combustion engine including fuel injection control. The fuel injection valve driving section 115 applies an open valve voltage generated in the open valve voltage generating section 116 or a battery voltage 52 to the fuel injection valve 3, and injects fuel.

The open valve voltage is a voltage for opening the fuel injection valve 3. The open valve voltage requires a voltage higher than the battery voltage to open a valve body against a high fuel pressure. Thus, the open valve voltage generating section 116 is required.

Next, the open valve voltage generating section 116 will be described. The open valve voltage generating section 116 includes three of an open valve voltage target-value adjusting section 114, an open valve voltage detecting section (comparator) 109, and an open valve voltage boosting section 54. An open valve voltage target value calculated by the CPU 104 is transmitted to an open valve voltage selecting-switch driving driver 108 of the open valve voltage target-value adjusting section 114. The open valve voltage target value output from the CPU 104 is set as a threshold for determining the presence or absence of the boosting operation of the open valve voltage boosting section 54 by the open valve voltage target-value adjusting section 114.

Next, the open valve voltage detecting section (comparator) 109 will be described. The open valve voltage target value and an open valve voltage actual value are compared by the open valve voltage detecting section (comparator) 109. If the open valve voltage actual value is less than the open valve voltage target value, the open valve voltage boosting section 54 boosts the open valve voltage and allows the open valve voltage actual value to be close to the open valve voltage target value. If the open valve voltage measured value is greater than the open valve voltage target value, boosting is not performed by the open valve voltage boosting section 54 and nothing is performed until the open valve voltage measured value is less than the open valve voltage target value by fuel injection of the fuel injection valve 3. Furthermore, here, a case where the open valve voltage target value is one is illustrated but the invention is not limited to the embodiment.

Next, an internal configuration of the open valve voltage target-value adjusting section 114 will be described. Here, as an example, a boosted voltage target value can be selected from three values of 40 V, 60 V, and 80 V. If the boosted voltage target value of 40 V is selected by the CPU 104, an Sw5 (switching element for the boosted voltage of 40 V) is turned ON, and an Sw6 (switching element for the boosted voltage of 60 V) and an Sw7 (switching element for the boosted voltage of 80 V) are turned OFF via the open valve voltage selecting-switch driving driver 108. In this case, the ratio of a resistor 110 for the boosted voltage of 40 V to a voltage dividing resistor 113 is set in advance to be 16:1. The voltage on an upstream side of the voltage dividing resistor 113 is just 2.5 V when the boosted voltage is 40 V. Similarly, a ratio of a resistor 111 for the boosted voltage of 60 V to the voltage dividing resistor 113 is set in advance to be 24:1 and a ratio of a resistor 112 for the boosted voltage of 80 V to the voltage dividing resistor 113 is set in advance to be 32:1. Moreover, in the embodiment, the open valve voltage of a high voltage capacitor 100 is not directly input into the open valve voltage detecting section (comparator) 109, but the divided voltage value is input as the open valve voltage actual value so as to satisfy the input rating of the open valve voltage detecting section (comparator) 109, but the invention is not limited to the embodiment.

The divided voltage value is compared to a reference voltage of 2.5 V by the open valve voltage detecting section 109 and a compared result is transmitted to the open valve voltage boosting section 54. The open valve voltage boosting section 54 performs starting or stopping of the boosting operation of the open valve voltage based on the compared result.

Moreover, means for varying a voltage dividing ratio of the boosted voltage is not limited to the switching of a plurality of voltage dividing resistors and, for example, the voltage dividing ratio may be varied by varying a resistance value of a variable resistor. Furthermore, the open valve voltage target value may be adjusted by fixing the voltage dividing ratio and varying the reference voltage for comparing to the divided voltage.

Next, an internal configuration of the open valve voltage boosting section 54 will be described. The high voltage capacitor 100, a boosted voltage element 101, and an Sw4 (switching element for the boosted voltage) are included on the inside of the open valve voltage boosting section 54. If power supply enters boosted voltage control means 102 and the open valve voltage detecting section 109 detects that the open valve voltage is insufficient with respect to the target value, the Sw4 repeats turning ON/OFF at a high speed and the voltage is boosted to a predetermined voltage.

Thus, for example, a configuration is provided such that if the voltage by fuel injection is lower than the target value, the open valve voltage is sequentially boosted and supplemented.

More specifically, the target value may include an upper limit target value and a lower limit target value such that the open valve voltage is adjusted in a predetermined range. Thus, if the open valve voltage reaches the upper limit target value, the boosting operation by the open valve voltage boosting section 54 is stopped and if the open valve voltage drops to the lower limit target value, the boosting operation by the open valve voltage boosting section 54 can be started. Thus, the open valve voltage can be adjusted so as to be within a predetermined range.

In this case, as the target value that is adjusted by the open valve voltage target-value adjusting section 114, if at least one of the upper limit target value and the lower limit target value is adjusted, it is possible to adjust the open valve voltage that is actually generated. However, it is preferable that a variation width of the open valve voltage can be further reduced by adjusting both target values. In addition, the above description is an example of the target value and the invention is not limited to the aspect described above. As another example, the open valve voltage boosting section 54 in which a boosted voltage stop condition is that the open valve voltage reaches the upper limit target value and a boosted voltage start condition is set in synchronization with fuel injection start timing, is usable. Also in this case, since the upper limit target value is adjusted by the open valve voltage target-value adjusting section 114, it is possible to obtain the same advantageous effects.

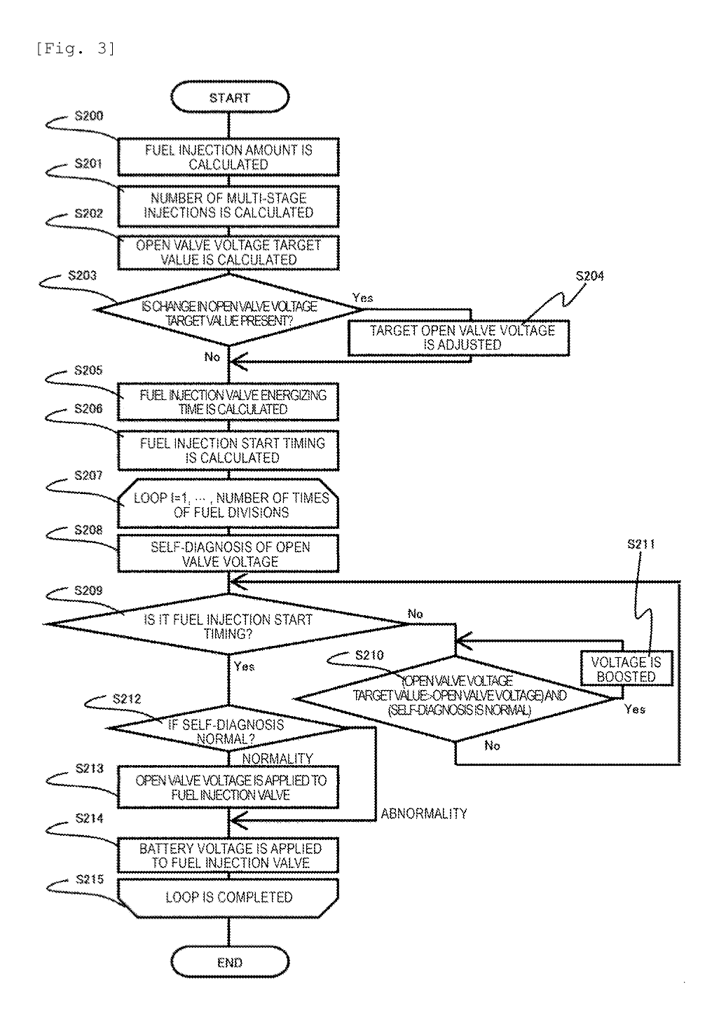

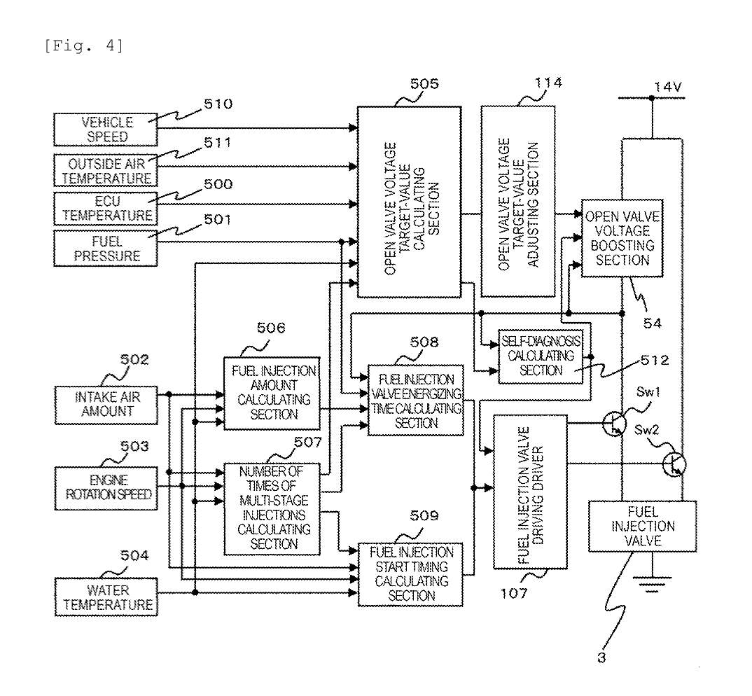

Next, the embodiment will be described with reference to the flowchart of fuel injection of FIG. 3 and a control block diagram of FIG. 4. The flowchart of FIG. 3 illustrates fuel injection of one cylinder in one cycle of the internal combustion engine.

In step 200 (S200), a fuel injection amount is calculated (block 506). The fuel injection amount is calculated based on an intake air amount 502, an engine speed 503, and a water temperature 504.

In step 201 (S201), the number of times of the multi-stage injections is calculated (block 507). The number of times of the multi-stage injections is calculated based on the intake air amount 502, the engine speed 503, and the water temperature 504. The number of times of the multi-stage injections indicates the number of times fuel is injected by being divided in each cylinder per one cycle. In a driving region on a low rotation and low load side, since the flowing of mixed gas within the combustion chamber of the internal combustion engine is low, the number of times of the multi-stage injections is increased. Furthermore, combustion stability is ensured by increasing the number of times of the multi-stage injections to promote early activation of a catalyst when the water temperature is low.

In step 202 (S202), the open valve voltage target value is calculated (block 505). The open valve voltage is a voltage applied to the fuel injection valve when opening the fuel injection valve. As the number of times of the multi-stage injections increases, an opportunity to boost the open valve voltage increases, heat is generated in the open valve voltage boosting section, the temperature within the ECU is excessively increases, and there is a concern that the electronic component within the ECU malfunctions or fails. Thus, a temperature sensor is provided on the inside of the ECU and if an ECU temperature 500 is high, it is determined that heat is generated in the open valve voltage generating section and the open valve voltage target value is reduced.

Otherwise, even if the ECU temperature sensor is not present, it is possible to estimate the ECU temperature. For example, if the ECU is provided within an engine room, it is possible to estimate the temperature of the periphery of the ECU by an outside air temperature 511, a vehicle speed 510, and the water temperature 504. When considering the number of times of the multi-stage injections per unit time obtained from a number of times of the multi-stage injections 507, it is possible to estimate the ECU temperature more accurately. Moreover, the open valve voltage target value maybe controlled on the condition that an estimated value or a measured value of the ECU temperature increases to a predetermined value or more, but the invention is not limited to the embodiment. For example, the open valve voltage target value maybe controlled on the condition when it is predicted the ECU temperature increases. Thus, the open valve voltage target value is controlled by an actual ECU temperature or an estimated ECU temperature.

On the other hand, if the fuel pressure 501 is high, when the open valve voltage is low, the fuel injection valve is unlikely to be opened and an adverse effect that deterioration of the exhaust and fuel consumption performance also occurs. Thus, it is easy to open the valve and deterioration of exhaust and the fuel consumption performance is prevented by increasing the target value of the open valve voltage according to an increase in the fuel pressure.

In step 203 (S203), the open valve voltage target value in (S202) is compared to the previous value and it is determined whether or not a change is present.

In step 204 (S204), if a change is present in the open valve voltage target value in (S204), the open valve voltage target value is adjusted (block 114).

In step 205 (S205), a fuel injection valve energizing time 508 is calculated. The fuel injection valve energizing time 508 is calculated based on a fuel injection amount 506, the fuel pressure 501, the number of times of the multi-stage injections 507, and the open valve voltage (block 508). The invention is characterized by correcting the fuel injection valve energizing time by a height of the open valve voltage.

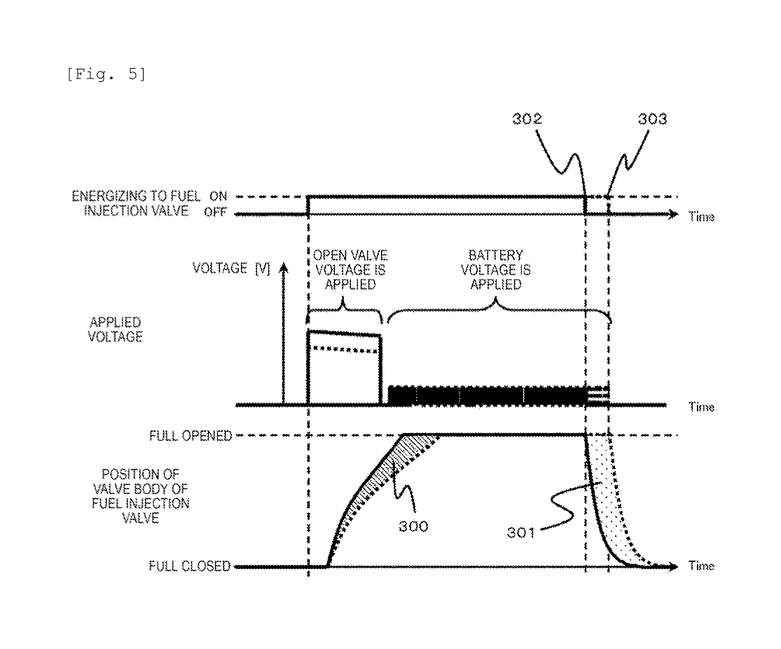

More specifically, correction of the fuel injection valve energizing time will be described with reference to FIG. 5. FIG. 5 illustrates a case where the fuel injection valve is energized. After energizing is turned ON, the fuel injection valve applies the open valve voltage and the valve is opened. Thereafter, the battery voltage is applied and the open state of valve is maintained. After an application pulse is turned OFF, the fuel injection valve is closed by a spring force of the fuel injection valve and the fuel pressure.

Here, when viewing a valve body position of the fuel injection valve, in a case where the open valve voltage is small (broken line portion), the valve body of the fuel injection valve is slowly opened with respect to a case where the open valve voltage is large (solid line portion). Thus, the fuel injection amount is reduced as much as an area (300 in the view) of a hatched portion . Thus, when injecting the same fuel amount irrespective of the open valve voltage, the area (300 in the view) of the hatched portion and an area (301 in the view) of the dotted line portion are equal to each other by correcting an application pulse time from point 302 to point 303 in the view and thereby the fuel injection amounts are equal to each other. Thus, the fuel injection amount is corrected by correcting an energizing time of the fuel injection valve.

Furthermore, if the number of times of the multi-stage injections is three, three fuel injection valve energizing times 508 are calculated.

In step 206 (S206), a fuel injection start timing 509 is calculated (block 509). The fuel injection start timing 509 is calculated based on the intake air amount 502, the engine speed 503, the water temperature 504, and the number of times of the multi-stage injections 507. Here, if the number of times of the multi-stage injections is three, three types of fuel injection start timing 509 are calculated.

Step 207 (S207) indicates the start of a process for repeatedly injecting fuel up to the number of times of the multi-stage injections. Here, when fuel injection is performed by the number of times of the multi-stage injections and is completed, the process is completed.

In step 208 (S208), self-diagnosis (block 512) of the open valve voltage is performed. The diagnosis is performed by Expression 1.

|Target open valve voltage target value−the open valve voltage actual value|>the predetermined value [Expression 1]

That is, if an absolute value of a difference between the open valve voltage target value calculated by the open valve voltage target-value calculating section (block 505) and the open valve voltage actual value is greater than a predetermined value, the self-diagnosis is is performed abnormally.

In step 209 (S209), it is examined whether or not it is the fuel injection start timing. If it is YES, it is determined to be fuel injection.

In step 210 (S210), it is examined whether or not the open valve voltage is less than the open valve voltage target value and the self-diagnosis is performed normally. Here, if it is YES, in step 211 (S211), the voltage is boosted in an open valve voltage boosting section (block 54). If it is NO, the process returns to before step 209 (S209).

In step 212 (S212), it is determined whether diagnosis of (S208) is normal or abnormal. If it is normal, in fuel injection, step 213 (S213) and step 214 (S214) are performed by a fuel injection valve driving driver (block 107). That is, the open valve voltage and the battery voltage are applied to the fuel injection valve, and fuel injection is performed. On the other hand, in (S212), if it is determined that the self-diagnosis is abnormal, step 213 (S213) is not performed and only step 214 (S214) is performed. That is, the open valve voltage is not applied and only the battery voltage is applied. This is performed to prevent failure of the fuel injection valve due to failure of the open valve voltage boosting section (block 54). Furthermore, if only the battery voltage is applied, since an opening valve time is extremely extended, control is performed to also extend the fuel injection valve energizing time.

In step 215 (S215), the process proceeds to beginning (S207) of a repeating process. According to the invention as described above, even if heat generation in the control device increases, it is possible to suppress heat generation in the control device without requiring a device such as the cooling fan. Then, if multi-stage injection control is performed, even if an opportunity to boost the voltage of the battery voltage increases and then heat generation amount in the control device increases, it is possible to suppress heat generation while maintaining the number of times of the injections by reducing the target open valve voltage of the fuel injection valve. Thus, even if heat generation in the control device occurs, since it is possible to maintain the number of times of the multi-stage injections, exhaust performance is improved.

In addition, according to the invention, the temperature of the control device is detected or is estimated by the outside air temperature, the vehicle speed, the cooling water temperature, and the number of times of the fuel injections per unit time. If the estimated temperature is high, it is determined that heat generation in the open valve voltage generating means increases, an opportunity to generate a high voltage of the open valve voltage generating means is reduced and it is possible to suppress heat generation by reducing the target value of the open valve voltage.

Furthermore, according to the invention, if the fuel pressure is high and the open valve voltage is low, since the fuel injection valve is unlikely to be opened and the emission performance and the fuel consumption performance deteriorate, the valve is likely to be opened and deterioration of the emission performance and the fuel consumption performance is prevented by increasing the target value of the valve open voltage.

Furthermore, according to the invention, it is possible to compensate an error of the fuel injection amount generated by adjustment of the open valve voltage by correction. That is, if the open valve voltage is low, since it takes time by opening of the fuel injection valve compared to a case where the open valve voltage is high, it is possible to correct a pulse width to be long.

Furthermore, according to the invention, abnormality of the open valve voltage generating means or the open valve voltage detecting means is detected from the difference therebetween. If the open valve voltage generating means fails, since there is a concern that the fuel injection valve also fails, it is possible to prevent failure of fuel injection valve in advance by detecting abnormality and performing fail-safe.

### REFERENCE SIGNS LIST

3 . . . fuel injection valve, 7 . . . ECU (engine control unit), 52 . . . battery, 54 . . . open valve voltage boosting section, 55 . . . ignition switch, 100 . . . high voltage capacitor, 101 . . . boosted voltage element (inductance element), 102 . . . boosted voltage control means, 103 . . . charging diode, 104 . . . CPU (central processing unit), 105 . . . current detecting resistor, 106 . . . boosted voltage detecting section, 107 . . . fuel injection valve driving driver, 108 open valve voltage selecting-switch driving driver, 109 . . . open valve voltage detecting section (comparator), 110 . . . resistor for boosted voltage of 40 V, 111 . . . resistor for boosted voltage of 60 V, 112 . . . resistor for boosted voltage of 80 V, 113 . . . voltage dividing resistor, 114 . . . open valve voltage target-value adjusting section, 115 . . . fuel injection valve driving section, 116 . . . open valve voltage generating section

1.-12. (canceled)

13. A control device of a cylinder injection type internal combustion engine comprising:
a boosting circuit that generates a boosted voltage by boosting a battery voltage; and
a driving circuit that drives a fuel injection valve by using the battery voltage and the boosted voltage,
wherein the driving circuit drives the fuel injection valve so as to perform a plurality of times of split injections of fuel during one stroke of the cylinder injection type internal combustion engine, and
wherein the control device further comprises a boosted voltage adjusting section that adjusts a target boosted voltage of the boosting circuit based on intervals of the split injection.

14. A control device of a cylinder injection type internal combustion engine comprising:
a boosting circuit that generates a boosted voltage by boosting a battery voltage; and
a driving circuit that drives a fuel injection valve by using the battery voltage and the boosted voltage,
wherein the driving circuit drives the fuel injection valve so as to perform a plurality of times of split injections of fuel during one stroke of the cylinder injection type internal combustion engine, and
wherein the control device further comprises a boosted voltage adjusting section that adjusts a target boosted voltage of the boosting circuit based the number of the split injections.

15. The control device of a cylinder injection type internal combustion engine according to claim 13,
wherein the driving circuit drives the fuel injection valve so as to perform a plurality of times of split injections of fuel during one stoke of the cylinder injection type internal combustion engine and the boosted voltage adjusting section adjusts the target boosted voltage of the boosting circuit based on the number of times of the split injections.

16. The control device of a cylinder injection type internal combustion engine according to claim 13, further comprising:
fuel pressure detecting unit that detects a fuel pressure being supplied to the fuel injection valve,
wherein the target boosted voltage of the boosting circuit is adjusted based on a detection result of the fuel pressure detecting unit.

17. The control device of a cylinder injection type internal combustion engine according to claim 15, further comprising:
a detecting unit that detects an outside air temperature, a vehicle speed, and a coolant temperature of the cylinder injection type internal combustion engine,
wherein the boosted voltage adjusting section adjusts the target boosted voltage of the boosting circuit using at least one of the outside air temperature, the vehicle speed, and the coolant temperature.

18. The control device of a cylinder injection type internal combustion engine according to claim 13,
wherein the boosted voltage adjusting section includes a voltage dividing resistor for dividing the boosted voltage, a voltage dividing ratio switching circuit that switches the voltage dividing ratio by the voltage dividing resistor, and a comparison circuit that compares the boosted voltage that is divided and a reference voltage that is set in advance, and
wherein the boosting circuit performs a boosting operation based on a comparison result of the comparison circuit.

19. The control device of a cylinder injection type internal combustion engine according to claim 18,
wherein the voltage dividing ratio switching circuit switches the voltage dividing ratio by switching a plurality of voltage dividing resistors or by varying a resistance value of the voltage dividing resistor.

20. The control device of a cylinder injection type internal combustion engine according to claim 13,
wherein the boosted voltage adjusting section includes a comparison circuit that compares the boosted voltage and a reference voltage that is set in advance, and reference voltage varying unit that varies the reference voltage, and
wherein the boosting circuit performs a boosting operation based on a comparison result of the comparison circuit.

21. The control device of a cylinder injection type internal combustion engine according to claim 13,
wherein a current waveform energizing the fuel injection valve is variable based on the target boosted voltage.

22. The control device of a cylinder injection type internal combustion engine according to claim 13,
wherein an abnormality determination unit is provided which determines that one of the boosting circuit and the unit for detecting the boosted voltage is abnormal if an absolute value of a difference between the target boosted voltage and the boosted voltage exceeds a predetermined value.

23. The control device of a cylinder injection type internal combustion engine according to claim 21,
wherein if the abnormality determination unit determines the abnormality, stopping of the boosting circuit or driving only of the battery voltage to the fuel injection valve is performed.

24. The control device of a cylinder injection type internal combustion engine according to claim 13,
wherein the target boosted voltage includes an upper limit target value for determining boosting stop of the boosting circuit and a lower limit target value for determining boosting start of the boosting circuit, and
wherein the boosted voltage adjusting section adjusts at least one of the upper limit target value and the lower limit target value.
